(19) United States
(12) Patent Application Publication
(10) Pub. No.: US 2020/0156867 A1
(43) Pub. Date: May 21, 2020

(54) METHOD FOR TAKING, PLACING AND CONVEYING MATERIALS

(71) Applicant: Jiangsu Fine Storage Information Technology Co., Ltd., Changshu City (CN)

(72) Inventors: Yilin LIU, Wuhan City (CN); Hui LUO, Changsha County (CN)

(73) Assignee: Jiangsu Fine Storage Information Technology Co., L td., Changshu City (CN)

(21) Appl. No.: 16/196,240

(22) Filed: Nov. 20, 2018

(51) Int. Cl. B65G 1/04; G11B 7/26

(52) U.S. Cl. CPC B65G 1/0407; B65G 2201/022; G11B 7/265

(57) ABSTRACT

A method for taking, placing and conveying materials includes taking materials: a clamping device of a mechanical gripper is controlled by a control cabinet to move onto a storage cabinet to open a storage unit and to take materials away; placing the materials: the control cabinet controls processing units of a processing bin to open, the clamping device places the materials on the processing units, and the processing units are closed; processing the materials: the materials are processed by the processing units; and collecting the materials: the control cabinet controls the processing units of the processing bin to open, and the materials on the processing units are taken away by the clamping device and are placed back into the storage unit of the storage cabinet. The method for taking, placing and conveying materials is highly automated low in labor intensity, and high in work efficiency.

### FIELD

The invention belongs to the technical field of automatic equipment, in particular to a method for taking, placing and conveying materials.

### BACKGROUND

With the development of economy and society and the improvement of technology, in order to keep up with the development of times, reforms and innovations in traditional industries are needed to replace traditional manual work by workers with intelligent and automatic work to liberate the labor force, improve production efficiency, save energy and protect the environment. For instance, in the CD processing industry, CDs are manually transferred between production lines and production workshops in the previous time, and manual operation is involved in many procedures, which results in disorganized management, low work efficiency, heavy workloads and errors; in addition, CDs are likely to be stained, damaged, disordered or even lost due to contact with workers, which is not in conformity with the high surface maintenance requirement of the CDs.

### SUMMARY

To overcome the drawbacks and defects of the prior art, the invention provides a method which is for taking, placing and conveying materials and is high in automation degree, low in labor intensity and high in work efficiency.

The following technical solution is adopted by the invention to settle the corresponding technical issue:

A method for taking, placing and conveying materials comprises the following steps:

S101, taking materials, particularly, a control cabinet controls a clamping device of a mechanical gripper to move onto a storage cabinet to open a storage unit, and then the materials are taken away by the clamping device;

S102, placing the materials, particularly, the control cabinet controls processing units of a processing bin to open, the clamping device places the materials on the processing units, and then the processing units are closed;

S103, processing the materials, particularly, the materials are processed by the processing units; and

S104, collecting the materials, particularly, the control cabinet controls the processing units of the processing bin to open, and then the materials on the processing units are taken away by the clamping device and are placed back into the storage unit of the storage cabinet.

Preferably, in S101, after being taken out of the storage unit by the clamping device, the materials are placed on a middle transfer device and then are taken away by a clamping device on the other side of the mechanical gripper from the middle transfer device.

Preferably, when the processing bin and the storage unit are located on different sides of the mechanical gripper, the materials clamped by the clamping device on one side of the mechanical gripper can be transferred onto the clamping device on the other side of the mechanical gripper via the middle transfer device, and thus, materials can still be taken and conveyed even if the processing bin and the storage cabinet are located on different sides.

Preferably, in S102, the clamping device sequentially places the materials on the processing units one-by-one.

Preferably, the clamping device places all clamped materials on a processing unit on which one material is to be placed, then the number of materials to be clamped by the clamping device is adjusted, and all the materials are sequentially placed on the processing units one-by-one to make sure that one material is placed on each processing unit, the situation that more than one material or no material is placed on a processing unit is avoided, and thus, the materials are placed more accurately.

Preferably, in S104, the clamping device sequentially collects the materials from the processing units one-by-one.

Preferably, the clamping device places all clamped materials on a processing unit from which a material is to be collected, then the number of materials to clamped by the clamping device is adjusted, and materials are sequentially collected one-by-one to make sure that the materials on all processing units are collected without being left, and thus, the materials are collected more accurately.

Preferably, S101 comprises the following step: S201, when the storage unit fails to be normally opened/closed, sending out, by the control cabinet, an abnormal detection signal to control the clamping device to re-open/re-close the abnormal storage unit or to pause. In this way, it is ensured that materials at a specified position are clamped by the clamping device, and damage caused by collision between the clamping device and the abnormal storage unit is avoided.

Preferably, S102 and S104 comprise the following step: S202, when one processing unit fails to be normally opened/closed, sending out, by the control cabinet, an abnormal detection signal to control the clamping device to pause. In this way, damage caused by collision between the clamping device and an abnormal tray is avoided.

Preferably, the method further comprises the following step: S105, after materials in one storage cabinet are processed, sending out, by the control cabinet, a prompt signal to control the clamping device to take materials from or place materials back into another storage cabinet or to pause. Workers disassemble the storage cabinet full of processed materials from the mechanical gripper and assemble another pre-prepared storage cabinet storing to-be-processed materials on the mechanical gripper. In this way, continuous production is realized without stopping machines or lines, and work efficiency is improved.

What needs to be additionally pointed out is that the method for taking, placing and conveying materials is based on the following devices:

a mechanical gripper, wherein the mechanical gripper comprises a bottom moving mechanism, a vertical moving mechanism, horizontal moving mechanisms and clamping devices, wherein the vertical moving mechanism is slidably connected to the bottom moving mechanism, the horizontal moving mechanisms are slidably connected to the vertical moving mechanism, and the clamping devices provided with rotating mechanisms are slidably connected to the horizontal moving mechanisms and are used for clamping materials; the mechanical gripper further comprises a middle transfer device, the two clamping device are symmetrically arranged on the front portion and the rear portion of the mechanical gripper and are able to move to any spatial positions within respective travel ranges to accurately clamp materials;

a storage cabinet, wherein the storage cabinet is located on one side of the mechanical gripper and is provided with storage units used for storing materials;

a processing bin, wherein the processing bin is located in front of or/and behind the mechanical gripper, and processing units used for processing materials are installed in the processing bin;

a control cabinet, wherein the control cabinet is used for comprehensive control over the mechanical gripper, the storage cabinet and the processing bin.

The materials are CDs, magnetic discs or other articles to be processed.

If the materials are CDs, the clamping device is able to clamp a plurality of CDs at the same time, and the processing units are CD drivers used for conducting reading, writing or recording on the CDs.

Compared with the prior art, the invention has the following beneficial effects: the method for taking, placing and conveying materials sequentially comprises the steps of material taking, material placing, material processing and material collection, so that materials are successively taken, placed, conveyed and processed; and the method is high in automation degree, replaces manual transferring, greatly relieves the labor intensity of workers, improves work efficiency and prevents materials from being stained, damaged or even lost.

### BRIEF DESCRIPTION OF THE FIGURES

FIG. 1 is a schematic view of an overall structure for a method for taking, placing and conveying materials of the invention;

FIG. 2 is a side view of a connection structure for the method for taking, placing and conveying materials of the invention;

FIG. 3 is a top view of the connection structure for the method for taking, placing and conveying materials of the invention;

FIG. 4 is a topological diagram for the method for taking, placing and conveying materials of the invention;

FIG. 5 is a work flow diagram of the method for taking, placing and conveying materials of the invention;

FIG. 6 is an overall structural view of a mechanical gripper for the method for taking, placing and conveying materials of the invention;

FIG. 7 is an overall structural view of a storage cabinet for the method for taking, placing and conveying materials of the invention; and

FIG. 8 is an overall structural view of a processing bin for the method for taking, placing and conveying materials of the invention.

Reference signs: mechanical gripper 1; clamping device 1-1; middle transfer device 1-2; storage cabinet 2; storage unit 2-1; processing bin 3; processing unit 3-1; control cabinet 4.

### DETAILED DESCRIPTION

The invention is further expounded and explained below with reference to the accompanying drawings and embodiments.

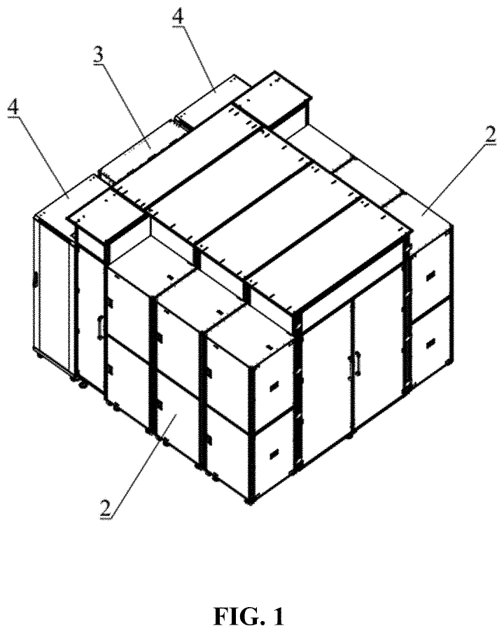

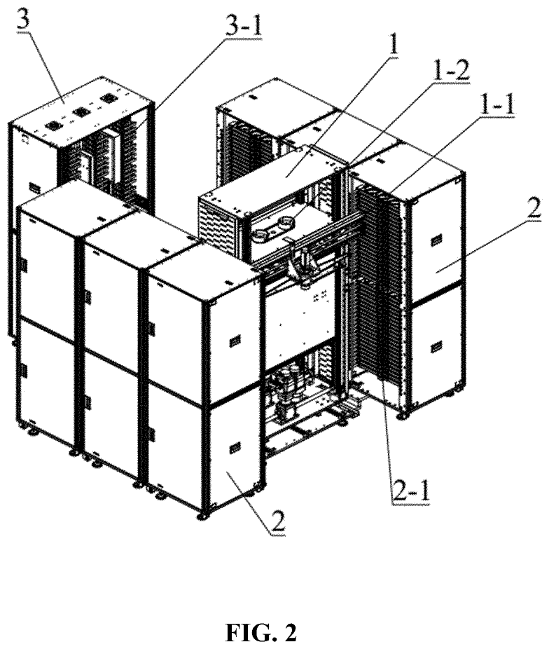

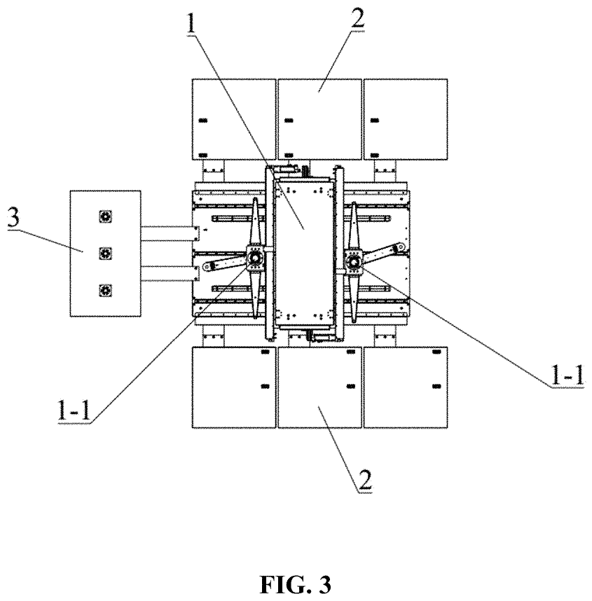

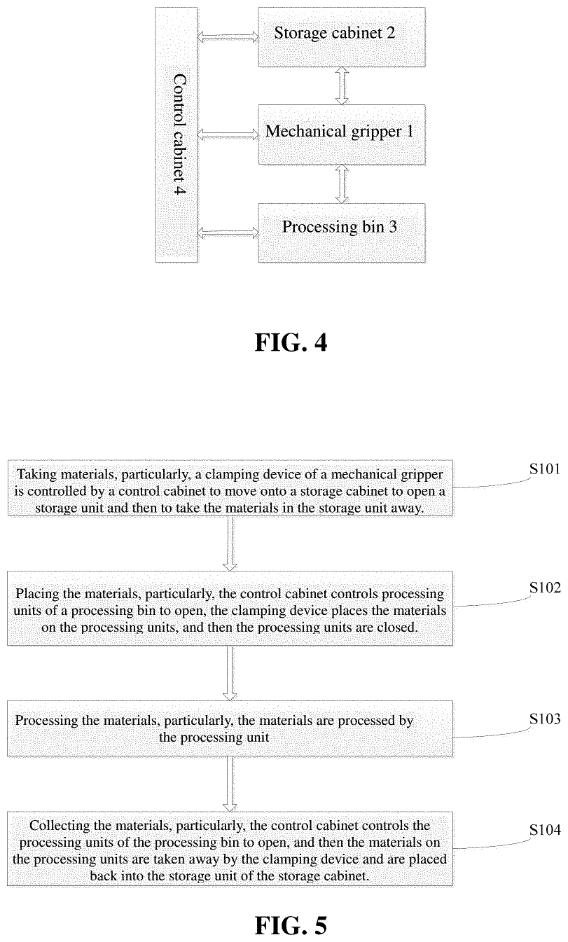

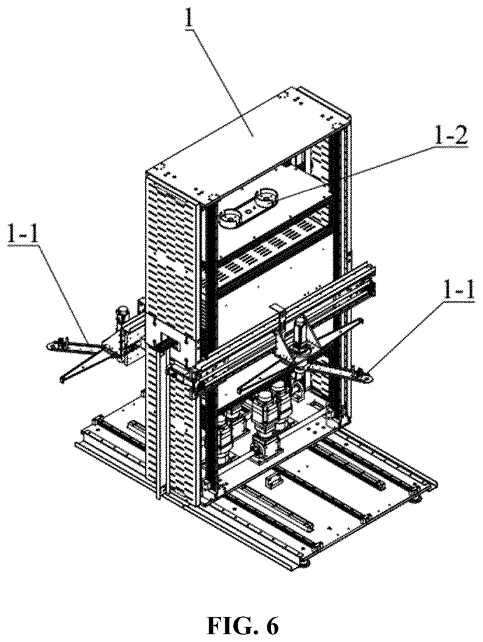

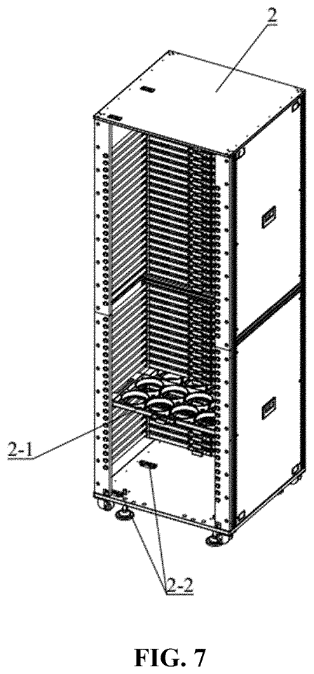

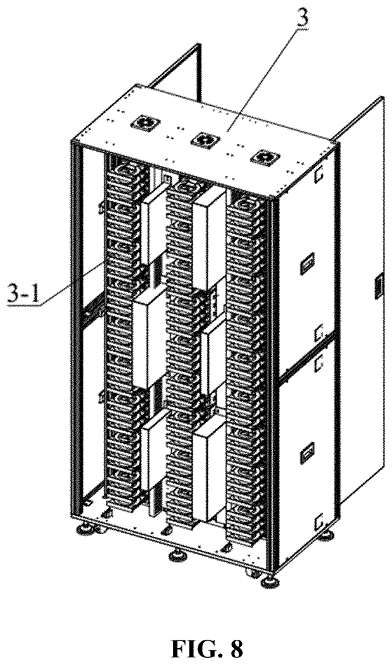

As shown in FIG. 1-8, a method for taking, placing and conveying materials is based on the following processing devices:

a mechanical gripper, wherein the mechanical gripper 1 comprises a bottom moving mechanism, a vertical moving mechanism, horizontal moving mechanisms and clamping devices 1-1, the vertical moving mechanism is slidably connected to the bottom moving mechanism, the horizontal moving mechanisms are slidably connected to the vertical moving mechanism, and the clamping devices 1-1 provided with rotating mechanisms are slidably connected to the horizontal moving mechanisms and are used for clamping materials; the mechanical gripper 1 further comprises a middle transfer device 1-2, and the two clamping devices are symmetrically arranged on the front portion and the rear portion of the mechanical gripper 1 and are able to move to any spatial positions within respective travel ranges to accurately clamp materials.

A storage unit 2, wherein the storage unit 2 is located on one side of the mechanical gripper 1 and is provided with storage units 2-1 used for storing materials.

A processing bin 3, wherein the processing bin 3 is located in front of or/and behind the mechanical gripper 1, and processing units 3-1 used for processing materials are installed in the processing bin 3.

A control cabinet 4, wherein the control cabinet 4 is used for comprehensive control over the mechanical gripper 1, the storage cabinet 2 and the processing bin 3.

The materials are CDs, magnetic discs or other articles to be processed.

If the materials are CDs, the clamping devices 1-1 is able to clamp a plurality of CDs at the same time, and the processing units 3-1 are CD drivers used for conducting reading, writing or recording operation on the CDs.

So, a method for taking, placing and conveying CDs comprises the following steps:

S101, the CDs are taken, particularly, the control cabinet 4 controls one clamping device 1-1 of the mechanical gripper 1 to move to a position where a specified storage unit 2-1 on the storage cabinet 2 can be drawn so as to pull the storage unit 2-1 out, and then CDs in the specified storage unit 2-1 are taken out by the clamping device 1-1;

S102, the CDs are placed, particularly, the control cabinet 4 controls specified CD drivers to eject trays out, then the clamping device 1-1 conveys the CDs to positions above the center lines of the trays and places the CDs on the trays, and afterwards, the trays retreat into the specified CD drivers;

S103, the CDs are processed, particularly, the CDs are processed by the CD drivers through writing, reading or recording;

S104, the CDs are collected, particularly, after the CDs are processed, the clamping device 1-1 moves to positions above the CD drivers with CDs to be collected, the CD drivers eject the trays out, CDs on the trays are taken away by the clamping device, the trays then retreat into the CD drivers, and the finally, the CDs are placed back into the storage unit 2-1 of the storage unit 2 by the clamping device 1-1.

Particularly, in S101, after being taken out of the specified storage unit 2-1 by the clamping device 1-1, the CDs are placed onto the middle transfer device 1-2 and are then taken away from the middle transfer device 1-2 by the clamping device 1-1 on the other side of the mechanical gripper 1.

In this embodiment, if the processing bin and the storage cabinet are located on different sides of the mechanical gripper, CDs on the clamping device on one side of the mechanical gripper can be transferred onto the clamping device on the other side of the mechanical gripper via the middle transfer device, and thus, CDs can still be taken and conveyed even if the processing bin and the storage cabinet are located on different sides.

Particularly, in S102, when two or more CDs are clamped by the clamping device 1-1, the clamping device 1-1 places all the CDs on the first tray ejected out of the CD driver, leaves the bottom CD on this tray and then takes away the rest of the CDs, after the first tray retreats into the CD driver, the clamping device 1-1 moves to the next tray to place the rest of CDs onto this tray, and this process is repeated till all the CDs are placed in trays one-by-one.

In this embodiment, the clamping device places all clamped CDs on a tray on which a CD is to be placed, then the number of CDs to be clamped by the clamping device is adjusted, and the materials are sequentially placed on trays one-by-one to make sure that only one CD is placed on each tray, so that the situation that more than one CD or no CD is placed in a tray is prevented, and the CDs are placed more accurately.

Particularly, in S104, when two or more CDs are to be collected, the clamping device 1-1 moves to a position above the first tray from which a first CD is to be collected in the processing bin 3 and clamps the first CD after the tray is ejected out; after the first tray retreats into the CD driver, the clamping device 1-1 moves to a position above the next tray from which a second CD is to be collected and places the first CD on the second CD after the second tray is ejected out, and then both the first CD and the second CD are clamped by the clamping device 1-1; after the second tray retreats into the CD driver, the clamping device 1-1 moves to the next tray with third CD to be collected so as to collect the third CD, and this process is repeated till the clamping device is full of CDs.

In this embodiment, the clamping device places all clamped CDs on a tray from which a CD is to be collected, then the number of CDs to be clamped by the clamping device is adjusted, and the CDs are sequentially collected one-by-one to make sure that CDs on all trays are collected without being left, and thus, the CDs are collected more accurately.

Particularly, S101 comprises the following step: S201, when the storage unit 2-1 fails to be pulled out of/pushed back into the storage cabinet 2, the control cabinet 4 sends out an abnormal detection signal to control the clamping device 1-1 to pull/push the abnormal storage unit 2-1 in position or to pause. In this way, it is ensured that CDs at a specified position are clamped by the clamping device 1-1, and damage caused by collision between the clamping device 1-1 and the abnormal storage unit 2-1 is avoided.

Particularly, S102 and S104 comprise the following step: S202, when a tray fails to be ejected out of or retreat into the CD driver, the control cabinet 4 sends out an abnormal detection signal to control the clamping device 1-1 to pause, so that damage caused by collision between the clamping device and the abnormal tray is avoided.

Particularly, the method further comprises the following step: S105, after materials in one storage unit 2 are processed, the control cabinet 4 sends out a prompt signal to control the clamping device 1-1 to take materials from or place materials back into another storage cabinet 2 or to pause. Workers disassemble the storage cabinet full of processed CDs from the mechanical gripper and assemble another pre-prepared storage unit storing to-be-processed CDs on the mechanical gripper. In this way, continuous production is realized without stopping machines/lines, and work efficiency is improved.

The invention has the following beneficial effects: the method for taking, placing and conveying materials sequentially comprises the steps of material taking, material placing, material processing and material collection, so that materials are successively taken, placed, conveyed and processed; and method is high in automation degree, replaces manual transferring, greatly relieves the labor intensity of workers, improves work efficiency and prevents materials from being stained, damaged or even lost.

Under the enlightenment of the above ideal embodiments of the invention, various alterations and modifications can be made by those skilled in this field without deviating from the technological thought of the invention. The technical scope of the invention is by no means limited to the contents in the specification and should be defined in terms of the claims when necessary.

What is claimed is:

1. A method for taking, placing and conveying materials, comprising the following steps:
S101, taking materials, wherein, a clamping device comprising a mechanical gripper is controlled by a control cabinet to move onto a storage cabinet to open a storage unit and then to take the materials in the storage unit away;
S102, placing the materials, wherein, the control cabinet controls processing units of a processing bin to open, the clamping device places the materials on the processing units, and then the processing units are closed;
S103, processing the materials, wherein, the materials are processed by the processing unit; and
S104, collecting the materials, wherein, the control cabinet controls the processing units of the processing bin to open, and then the materials on the processing units are taken away by the clamping device and are placed back into the storage unit of the storage cabinet.

2. The method for taking, placing and conveying materials according to claim 1, wherein in S101, after being taken out of the storage unit by the clamping device, the materials are placed on a middle transfer device and are then taken away by a clamping device on another side of the mechanical gripper from the middle transfer device.

3. The method for taking, placing and conveying materials according to claim 1, wherein in S102, the clamping device sequentially places the materials on the processing units one-by-one.

4. The method for taking, placing and conveying materials according to claim 1, wherein in S104, the clamping device sequentially collects the materials from the processing units one-by-one.

5. The method for taking, placing and conveying materials according to claim 1, wherein S101 comprises the following step: S201, when the storage unit fails to be normally opened/closed, sending out, by the control cabinet, an abnormal detection signal to control the clamping device to re-open/re-close the abnormal storage unit or to pause.

6. The method for taking, placing and conveying materials according to claim 1, wherein S102 and S104 further comprise the following step: S202, when one said processing unit fails to be normally opened/closed, sending out, by the control cabinet, an abnormal detection signal to control the clamping device to pause.

7. The method for taking, placing and conveying materials according to claim 1, wherein the method further comprises the following step: S105, after materials in one storage cabinet are processed, sending out, by the control cabinet, a prompt signal to control the clamping device to take materials from or place material into another storage cabinet or to pause.
